(19) United States
(12) Patent Application Publication
(10) Pub. No.: US 2013/0022845 A1
(43) Pub. Date: Jan. 24, 2013

(54) Battery Module System

(71) Applicants: Jason R. Davis, Commerce Township, MI (US); Marius O. Enache, LaSalle (CA)

(72) Inventors: Jason R. Davis, Commerce Township, MI (US); Marius O. Enache, LaSalle (CA)

(73) Assignee: A123 SYSTEMS, INC., Waltham, MA (US)

(21) Appl. No.: 13/520,319

(22) PCT Filed: Dec. 29, 2010
(86) PCT No.: PCT/US10/62351

§ 371 Date: Sep. 27, 2012

Related U.S. Application Data
(60) Provisional application No. 61/291,111, filed on Dec. 30, 2009.

(51) Int. Cl. H01M 2/10; H01M 10/50

(52) U.S. Cl. 429/72; 429/96; 429/99

(57) ABSTRACT

A battery module is disclosed where the battery module includes a variety of internal components. In one example, microcellular polyurethane pads are positioned between walls of the battery module and internal components of the battery module to reduced degradation that may be caused by operating the battery module in a vehicle. The pads may reduce vibration and interference between the battery module walls and interior battery components so that battery module life may be extended.

### TECHNICAL FIELD

The present application relates to the field of battery enclosure systems.

### BACKGROUND AND SUMMARY

Battery modules may be housed in an enclosure for various reasons, including maintaining a desired environment around the battery module. Further, such enclosures may include cooling systems, such as liquid coolant, for maintaining appropriate temperature of the battery module during operation.

The inventors herein have recognized, however, that when such enclosed battery modules are mounted in moving vehicles, vibration and other vehicle-related movement can cause relative motion between the battery module and the enclosure, as well as other components. For example, such movement may reduce contact between the battery module and certain heat transfer components related to the cooling system. This, in turn, can reduce effective cooling of the battery module, and reduce performance and/or overall life. Additionally, or alternatively, when the battery module is mounted horizontally in the vehicle, vertical motion during vehicle operation can be particularly degrading to connectors of the battery module. Degraded connections may also lead to reduced performance and/or overall life of the battery module.

As such, in one example, the battery module may be mounted in the enclosure with a microcellular polyurethane pad. For example, the battery module may include a plurality of stacked cells arranged with contactors on a top portion when mounted in a vehicle. The pad may then be positioned between the cells and a wall of an enclosure containing the battery module, such as a cover. In this way, vibration may be absorbed or damped via the pad, and further the module may be better protected from degradation. Further still, cooling contact of the module may be better maintained during vehicle operation, thereby maintaining better control of module temperature.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic view of an exemplary battery cell;

FIG. 2 shows a schematic view of an exemplary assembly of a battery cell stack;

FIG. 3 shows a schematic cross section view of one embodiment of a battery enclosure and mounting system;

FIG. 4 shows a schematic cross section view of one embodiment of a battery enclosure having a pad positioned between the battery cell stack and a corrugated wall of an enclosure; and

FIG. 5 shows a non-limiting application of the present system and method.

### DETAILED DESCRIPTION OF THE DEPICTED EMBODIMENTS

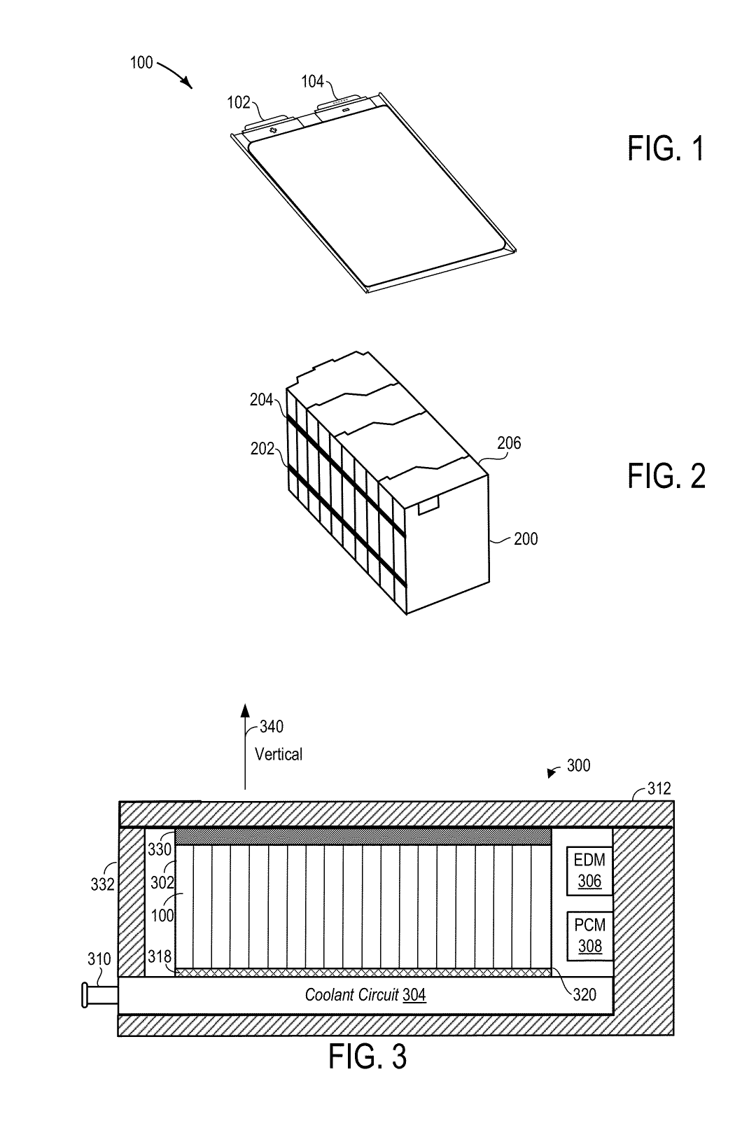

FIG. 1 shows an exemplary embodiment of a battery cell. Battery cell 100 includes cathode 102 and anode 104 for connecting to a bus (not shown). The bus can route charge from a plurality of battery plates to output terminals of a battery pack.

Referring now to FIG. 2, an exemplary assembly of a battery cell stack is shown. Battery stack 200 is comprised of a plurality of battery cells. The battery cells are strapped together by bands 202 and 204. Cover 206 provides protection for battery bus bars (not shown) that route charge from the plurality of battery cells to output terminals of a battery pack.

Referring now to FIG. 3, battery pack enclosure 300, having a lid 312, contains battery module (e.g., cell stack 302), coolant circuit 304, electrical distribution module (EDM) 306, and battery control module (BCM) 308. Coolant enters the coolant circuit at coolant connector 310. Coolant circuit 304 is in thermal communication with battery cell stack 302 via conductive grease 318 and a cold plate 320 that attaches to the individual battery cells. When heat is generated by cell stack 302, coolant circuit 304 transfers the heat to a location outside of battery pack 300. In one embodiment, coolant circuit 304 may be in communication with a vehicle radiator. EDM 306 controls the distribution of power from the battery pack to the load. BCM 308 controls ancillary modules such at the EDM and cell monitor and balance boards (MBB). The BCM may be comprised of a microprocessor having random access memory, read only memory, input ports, and output ports. Further, in some embodiments the BCM may have onboard sensors for determining humidity, temperature, and/or pressure in the battery enclosure.

Battery pack enclosure 300 further includes a pad 330, which in one example may be a microcellular urethane, such as microcellular polyurethane known by the tradename PORON®, a foam pad, or still other pads. In one specific example, the pad is non-woven, and resilient. While shown between the lid 312 and battery module in this example, the pad 330 may be positioned between the battery module and a side wall, such as side wall 332, of the enclosure. Further still, multiple pads may be positioned between battery module internal components (e.g., coolant circuit, cold plate, EDM, PCM, and battery cells) and the multiple sides and the top of the battery module. For example, the pads may be glued to one surface such at a wall of the enclosure and not glued to the opposite contacting surface (e.g., the battery cell stack). In another example, the pads may be held in position via a clamping force between two surfaces (e.g., a clamping force between an enclosure wall or lid and the battery cell stack). In still another example, pads may be positioned between internal components of the battery module to mitigate motion between internal battery components. For example, pads may be placed between adjacent battery cell stacks within the battery module. Note that line 340 indicates vertical in this example, where the lid 312 is positioned atop the battery module. Further, FIG. 3 illustrates how a plurality of cells may be mounted vertically, with the battery module horizontal, and with the connectors of the cells at a top of the stack.

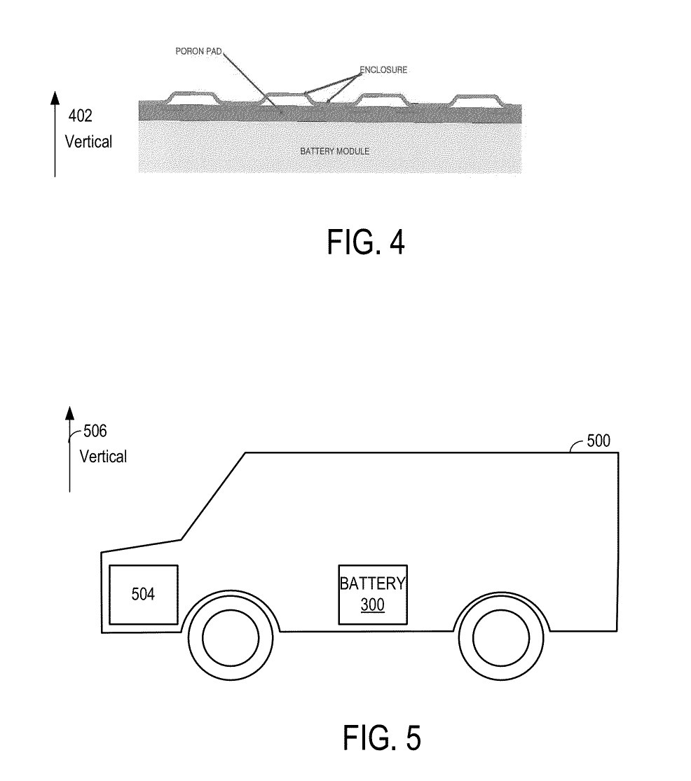

Still further examples of the position on pad 330 are illustrated in FIG. 4, which shows a portion of the battery module positioned with an example pad 330 positioned between the battery module and a wall of the enclosure, which may be a side wall, or a top wall, or a lid, of the enclosure. In this example, the wall is corrugated, and formed of a plastic.

Referring now to FIG. 5, a schematic view of a non-limiting application of the present system is shown. In particular, battery pack 300 is installed in a vehicle 500. The battery pack supplies energy to propel vehicle 500 via electric motor 504. Thus, battery pack 300 is electrically coupled to electric motor 504 and electric motor 504 is mechanically coupled to vehicle 500. In one embodiment, vehicle 500 may be propelled solely by electric motor 504. In another embodiment, vehicle 500 may be a hybrid vehicle that may be propelled by an electric motor and an internal combustion engine. As illustrated, line 506 indicates vertical in this example.

Thus, the system as illustrated in FIGS. 1-5 provides for a battery module, comprising: a battery cell stack comprised of at least one battery cell; an enclosure containing said at least one battery cell; and a resilient foam pad positioned between the battery cell stack and a wall of the enclosure. The battery module includes where said pad comprises a microcellular polyurethane. The battery includes where said wall comprises a corrugated section. The battery module includes where the corrugated section is formed of plastic. The battery module includes where said wall of said enclosure comprises a lid, and where said battery cell stack is positioned horizontally with each cell vertically mounted, and where said pad is positioned between a top of said battery cell stack and said lid. The battery module includes where said battery cell stack is electrically coupled to a motor, said motor mechanically coupled to an electric vehicle. The battery module includes where said enclosure includes a coolant circuit.

The system of FIGS. 1-5 also provides for a battery module, comprising: a battery cell stack comprised of a plurality of battery cells that are bound together with bands; an enclosure containing the plurality of battery cells; and a resilient foam pad positioned between said battery cell stack and a lid of said enclosure. The battery module further comprises positioning additional resilient foam pads positioned between battery module internal components and sides of said enclosure. The battery module includes where said internal components include at least one of a coolant circuit, cold plate, EDM, and PCM. The battery module includes where said lid is mounted vertically. The battery module includes where said sides of said enclosure are plastic. The battery module includes where said resilient foam pad is glued to said lid or held in a position via a clamping force between said lid and said battery cell stack. The battery module includes where said resilient foam pad is non-woven.

The system of FIGS. 1-5 also provides for a system, comprising: an electrically powered vehicle; a motor mechanically coupled to said electrically powered vehicle; and an enclosure containing a battery cell stack, with a resilient foam pad positioned between said battery cell stack and a wall of said enclosure, said battery cell stack electrically coupled to said motor. The system includes where said battery cell stack is mounted with electrical connectors of each battery cell stack positioned at a top of said battery cell stack with respect to vertical in said electrically powered vehicle, and where said resilient foam pad is mounted between said top of said battery cell stack an a lid of said enclosure. The system includes where said resilient foam pad is held in position via glue or a clamping force. The system includes where said wall is constructed of corrugated plastic. The system includes where said resilient foam pad is constructed of a microcellular polyurethane pad. The system further comprises a plurality of microcellular polyurethane pads positioned between battery module internal components and enclosure walls other than said wall of said enclosure.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A battery module, comprising:
a battery cell stack comprised of at least one battery cell;
an enclosure containing said at least one battery cell; and
a resilient foam pad positioned between the battery cell stack and a wall of the enclosure.

2. The battery module of claim 1, where said pad comprises a microcellular polyurethane.

3. The battery module of claim 2, where said wall comprises a corrugated section.

4. The battery module of claim 3, where corrugated section is formed of plastic.

5. The battery module of claim 4, where said wall of said enclosure comprises a lid, and where said battery cell stack is positioned horizontally with each cell vertically mounted, and where said pad is positioned between a top of said battery cell stack and said lid.

6. The battery module of claim 1, where said battery cell stack is electrically coupled to a motor, said motor mechanically coupled to an electric vehicle.

7. The battery module of claim 1, where said enclosure includes a coolant circuit.

8. A battery module, comprising:
a battery cell stack comprised of a plurality of battery cells that are bound together with bands;
an enclosure containing the plurality of battery cells; and
a resilient foam pad positioned between said battery cell stack and a lid of said enclosure.

9. The battery module of claim 8, further comprising positioning additional resilient foam pads positioned between battery module internal components and sides of said enclosure.

10. The battery module of claim 9, where said internal components include at least one of a coolant circuit, cold plate, EDM, and PCM.

11. The battery module of claim 8, where said lid is mounted vertically.

12. The battery module of claim 9, where said sides of said enclosure are plastic.

13. The battery module of claim 8, where said resilient foam pad is glued to said lid or held in a position via a clamping force between said lid and said battery cell stack.

14. The battery module of claim 8, where said resilient foam pad is non-woven.

15. A system, comprising:
an electrically powered vehicle;
a motor mechanically coupled to said electrically powered vehicle; and
an enclosure containing a battery cell stack, with a resilient foam pad positioned between said battery cell stack and a wall of said enclosure, said battery cell stack electrically coupled to said motor.

16. The system of claim 15, where said battery cell stack is mounted with electrical connectors of each battery cell stack positioned at a top of said battery cell stack with respect to vertical in said electrically powered vehicle, and where said resilient foam pad is mounted between said top of said battery cell stack an a lid of said enclosure.

17. The system of claim 15, where said resilient foam pad is held in position via glue or a clamping force.

18. The system of claim 15, where said wall is constructed of corrugated plastic.

19. The system of claim 15, where said resilient foam pad is constructed of a microcellular polyurethane pad.

20. The system of claim 15, further comprising a plurality of microcellular polyurethane pads positioned between battery module internal components and enclosure walls other than said wall of said enclosure.
